(19) United States
(12) Patent Application Publication
(10) Pub. No.: US 2008/0006961 A1
(43) Pub. Date: Jan. 10, 2008

(54) Method For Accelerating The Solid-Stating Of Polyethylene Terephthalate

(76) Inventor: Donald W. Hayward, Waterville, OH (US)

Correspondence Address: FRASER CLEMENS MARTIN & MILLER LLC, 28366 KENSINGTON LANE, PERRYSBURG, OH, 43551, US

(21) Appl. No.: 11/577,360

(22) PCT Filed: Oct. 3, 2005
(86) PCT No.: PCT/US05/35441

§ 371 Date: Apr. 17, 2007

Related U.S. Application Data
(60) Provisional application No. 60/619,667, filed on Oct. 18, 2004.

(51) Int. Cl. C08G 63/02; C08G 63/00

(52) U.S. Cl. 264/115

(57) ABSTRACT

A process for treating polyethylene terephthalate comprises comminuting the polyethylene terephthalate to prepare particles having an average mean particle size of about 300 microns or less, and solid-stating the polyethylene terephthalate particles.

### CROSS-REFERENCE TO RELATED APPLICATION

This Application claims the benefit of U.S. Provisional Patent Application Ser. No. 60/619,667, filed on Oct. 18, 2004.

### FIELD OF THE INVENTION

The present invention relates generally to a method for accelerating the solid-stating of polyethylene terephthalate (PET). More particularly, the invention is directed to accelerating the solid-stating of PET through particle size reduction.

### BACKGROUND OF THE INVENTION

PET resin is widely used for the manufacture of plastic containers, such as for example carbonated soft drink (CSD) bottles and other beverage containers. The preparation of beverage containers, and CSD bottles in particular, is very sensitive to the intrinsic viscosity (IV) of the PET from which the articles are produced. The IV must be within certain limits, or the physical properties of the resultant CSD bottles and beverage containers will be degraded. Generally, CSD and beverage containers should be prepared from PET having an IV from about 0.72 dg/L to about 0.84 dg/L.

Proper intrinsic viscosity for the manufacture of beverage containers, particularly CSD bottles, is conventionally achieved through the post reaction solid-stating of the PET from which the containers are made. However, this solid-stating procedure is time consuming, and results in an increased cost for the PET beverage container manufacturing process.

It would be desirable to develop a process for accelerating the solid-stating of PET, for the efficient manufacture of beverage containers.

### SUMMARY OF THE INVENTION

Accordant with the present invention, a process for treating polyethylene terephthalate has surprisingly been discovered. The process comprises the steps of comminuting the polyethylene terephthalate, to prepare particles having an average mean particle size of about 300 microns or less, and solid-stating the polyethylene terephthalate particles.

The inventive process is particularly useful for treating polyethylene terephthalate, for the subsequent preparation of beverage containers, particularly CSD bottles.

### DETAILED DESCRIPTION OF THE PREFERRED EMBODIMENT

The present invention is directed to a process for treating polyethylene terephthalate (PET), to accelerate the solid-stating of the PET, comprising the steps of comminuting the PET to prepare particles having an average mean particle size of about 300 microns or less, and solid-stating the PET particles.

Solid-stating is a process useful for raising the IV of PET. IV is an important physical characteristic which in large part determines the ultimate strength of the final product, for example, a CSD bottle or other beverage container. Bottles and containers produces from PET having a low intrinsic viscosity will not perform as well nor have the integrity of bottles and containers manufactured from PET having a higher intrinsic viscosity.

PET, unlike most other polymers, has the ability to be “put back together” in a solid-stating process, which raises the intrinsic viscosity to an acceptable level for use in the production of bottles and containers. Typically, post reaction PET resin pellets are subjected to high temperatures in the absence of oxygen. Solid-stating is generally accomplished just below the melting point of the PET, employing a dry gas stream flowing through a bed of the hot PET pellets. The dry gas may be any inert gas such as nitrogen or argon. Alternatively, the solid-stating may be carried out under a vacuum.

Because PET is a poly condensation polymer, solid-stating occurs over time, and results in molecular weight build through transesterification. The rate of solid-stating depends on diffusion mechanics to remove by-products of the process, and thermal dynamics to raise the temperature of the PET. According to the present invention, the reduction of the size of the PET particles, from the typical size of post-reactor pellets to a size less than or equal to about 300 microns, greatly improves and accelerates the solid-stating process, by decreasing the time required to raise the IV of the PET to the desired level.

According to the present invention, PET may be comminuted by any conventional method to particles having an average mean particle size less than or equal to about 300 microns. Methods for comminuting PET, such as for example by rotary blade mills, ball mills, rotary impact devices, and the like are well-known and need not be discussed further.

Following comminution of the PET, the particles are placed in a solid-stating reactor for subsequent treatment. The time required for solid-stating the PET particles is significantly less than for solid-stating an equal mass of post-reaction PET pellets.

The invention is more easily comprehended by reference to specific embodiments recited hereinabove which are representative of the invention. It must be understood, however, that the specific embodiments are provided only for the purpose of illustration, and that the invention may be practiced otherwise than as specifically illustrated without departing from its spirit and scope.

What is claimed is:

1. A process for treating polyethylene terephthalate, comprising:
comminuting the polyethylene terephthalate, to prepare particles having an average mean particle size of about 300 microns or less; and
solid-stating the polyethylene terephthalate particles.
